(19) United States
(12) Patent Application Publication
(10) Pub. No.: US 2015/0161353 A1
(43) Pub. Date: Jun. 11, 2015

(54) METHODS AND APPARATUS FOR IMPROVING HEALTHCARE

(71) Applicant: Symplmed Pharmaceuticals, LLC, Cincinnati, OH (US)

(72) Inventor: Erik Emerson, Pleasanton, CA (US)

(73) Assignee: SYMPLMED PHARMACEUTICALS, LLC, Cincinnati, OH (US)

(21) Appl. No.: 14/606,732

(22) Filed: Jan. 27, 2015

Related U.S. Application Data
(63) Continuation of application No. 14/508,147, filed on Oct. 7, 2014.
Application No. 14/508,147 is a continuation-in-part of application No. 14/255,089, filed on Apr. 17, 2014.
Application No. 14/255,089 is a continuation-in-part of application No. 13/284,423, filed on Oct. 28, 2011, now Pat. No. 8,738,398.
(60) Provisional application No. 61/408,560, filed on Oct. 29, 2010.

(51) Int. Cl. G06F 19/00

(52) U.S. Cl. CPC G06F 19/3456

(57) ABSTRACT

The instant disclosure provides methods and apparatus for prescribing drugs and obtaining and using outcome information associated with use of the prescribed drugs. Doctors and patients may be registered in a centralized system though which drugs may be prescribed and delivered directly to the patients together with outcome data collection apparatus. Outcome data associated with use of the prescription drug is entered into the system and used in a variety of ways. The instant invention also includes membership fee-based models, permits virtual office visits between doctors and patients, and virtual inventory management systems.

### CROSS-REFERENCE TO RELATED APPLICATIONS

This application is a continuation of co-pending U.S. patent application Ser. No. 14/508,147, filed Oct. 7, 2014, which is a continuation-in-part of co-pending U.S. patent application Ser. No. 14/255,089, filed on Apr. 17, 2014, which is a is a continuation-in-part of U.S. patent application Ser. No. 13/284,423, filed on Oct. 28, 2011 (which issued as U.S. Pat. No. 8,738,398 on May 27, 2014), which claims priority to U.S. Provisional Patent Application No. 61/408,560, filed on Oct. 29, 2010, each of which is hereby incorporated by reference in its entirety.

### FIELD OF THE INVENTION

The instant invention relates to improvements in healthcare, in particular to systems and methods for the centralized prescribing and fulfillment of drugs for indicated medical conditions, and for monitoring and tracking patient compliance and treatment response to the use of such drugs.

### BACKGROUND OF RELATED TECHNOLOGY

In the current prescription drug system, patients typically fill prescriptions at a retail pharmacy or by mail order. However, due to the need for patient involvement in completing the process of filling prescriptions, such as, for example, the inconvenience of waiting for the pharmacy to obtain the drug, traveling to the pharmacy, submitting a mail order prescription, the high cost of the drugs, and other factors, many prescriptions are never filled.

In addition, once the drugs are prescribed, there may be no tracking as to whether the prescription is filled, and/or no outcome data or transparency as to the efficacy of the drugs. Doctors, patients, and insurers are unable to compare the effectiveness of different drugs on different types of patients.

### SUMMARY OF THE INVENTION

In certain exemplary, non-limiting embodiments, the instant invention is directed to computer-implemented methods of prescribing and distributing a prescription drug to a patient and for monitoring and tracking the patient's response to use of the prescription drug, including the steps of: (a) electronically receiving and storing, in a database, data concerning an indicated medical condition; (b) electronically receiving and storing, in a database, data concerning a prescription drug indicated for use treating the indicated medical condition; (c) electronically receiving and storing, in a database, one or more outcome data types pre-selected by one or more medical professionals; the one or more outcome data types being associated in the database with the indicated medical condition and the prescription drug; the one or more outcome data types correlating the effect of use of the prescription drug by a patient diagnosed with the indicated medical condition to the treatment of the indicated medical condition in the patient; (d) electronically receiving and storing, in a database, data concerning an outcome information monitoring device; the outcome information monitoring device being capable of obtaining patient outcome information corresponding to the one or more outcome data types; (e) electronically receiving doctor registration data from a doctor, and storing the doctor registration data in a database; the doctor registration data including information concerning the doctor and an associated practice; (f) electronically receiving patient registration data from at least one of the doctor and the patient, and storing the patient registration data in a database; the patient registration data including information concerning the patient; (g) electronically receiving patient payment information from the patient, and storing the patient payment information in a database; (h) electronically processing a patient payment using the patient payment information of step (g); (i) electronically receiving prescription data from the doctor, and storing the prescription data in a database; the prescription data including information concerning the patient, the patient's indicated medical condition and the prescription drug indicated for use in treating the patient's indicated medical condition; (j) electronically verifying that doctor registration data is stored in the database of step (e) for the doctor providing the prescription data of step (i); (k) updating inventory data stored in a database; the inventory data associated with the practice and the prescription drug; the inventory data including an available quantity of the prescription drug; wherein updating the stored inventory data includes decreasing the available quantity of the prescription drug; (l) after processing the patient payment in step (h) and verifying the doctor registration data in step (j), causing the prescription drug to be provided to the patient as indicated by the patient's patient registration data stored in the database of step (f); the prescription drug being provided directly to the patient from a single prescription drug fulfillment source one or a plurality of times, as indicated by the prescription data stored in the database of step (i); (m) causing an outcome information monitoring device to be provided to the patient based on the outcome information monitoring device data stored in the database of step (d); (n) electronically receiving fulfillment data, and storing the fulfillment data in a database; the fulfillment data including information concerning fulfillment of the prescription drug by the single prescription drug fulfillment source of step (l); and (o) electronically receiving, from the patient, patient outcome information corresponding to the one or more outcome data types and obtained by the outcome information monitoring device provided to the patient in step (m), and storing the patient outcome information in a database; the steps (a)-(o) being implemented in a computer system including one or more processors configured to execute one or more computer programs; and the fulfillment data and the patient outcome information being available to the doctor through one or more electronic interfaces of the computer system.

In certain exemplary, non-limiting embodiments, the instant invention further includes the step of electronically verifying the availability of the prescription drug based upon the available quantity within the stored inventory data.

In certain exemplary, non-limiting embodiments, the instant invention further includes the steps of: electronically receiving an inventory purchase request, the inventory purchase request including information concerning the practice, the prescription drug, and a quantity of the prescription drug; and in response to receiving the inventory purchase request, updating the stored inventory data to increase the available quantity of the prescription drug.

In certain exemplary, non-limiting embodiments, the instant invention further includes the step of electronically verifying that the requested quantity of the prescription drug is available in an actual inventory.

In certain exemplary, non-limiting embodiments, the instant invention further includes the steps of: calculating a total cost to patients of prescription drugs prescribed by the practice within a predetermined time period; calculating a total cost to the practice of the prescribed prescription drugs; and causing a payment to be made to the practice; the payment being an amount based upon the total cost to the patients and the total cost to the practice.

In certain exemplary, non-limiting embodiments, the predetermined time period is a previous 30 day time period.

In certain exemplary, non-limiting embodiments, the predetermined time period is a previous 90 day time period.

In certain exemplary, non-limiting embodiments, the instant invention further includes the steps of: calculating a total cost to the practice of prescription drugs prescribed by the practice within a predetermined time period; and causing an invoice to be sent to the practice; the invoice including an amount based upon the total cost to the practice.

In certain exemplary, non-limiting embodiments, the prescription drug is provided from a central distribution facility.

In certain exemplary, non-limiting embodiments, the stored inventory data includes: a purchases table having a date/time column, a practice identifier column, a product identifier column, and a quantity column; and a sales table having a date/time column, a practice identifier column, a product identifier column, and a quantity column.

In certain exemplary, non-limiting embodiments, the stored inventory data includes a virtual inventory table having a practice identifier column, a product identifier column, and a quantity column.

In certain exemplary, non-limiting embodiments, updating the stored inventory data includes inserting a row into a sales table having a date/time column, a practice identifier column, a product identifier column, and a quantity column.

In certain exemplary, non-limiting embodiments, electronically verifying the prescription drug is available includes querying a virtual inventory table having a practice identifier column, a product identifier column, and a quantity column.

In certain exemplary, non-limiting embodiments, updating the stored inventory data includes inserting a row into a purchases table having a date/time column, a practice identifier column, a product identifier column, and a quantity column.

In certain exemplary, non-limiting embodiments, electronically verifying that the requested quantity of the prescription drug is available in an actual inventory includes querying a virtual inventory table having a practice identifier column, a product identifier column, and a quantity column.

In certain exemplary, non-limiting embodiments, calculating the total cost to patients includes querying a sales table having a date/time column, a practice identifier column, a product identifier column, and a quantity column; and wherein calculating a total cost to the practice includes querying a purchases table having a date/time column, a practice identifier column, a product identifier column, and a quantity column.

In certain exemplary, non-limiting embodiments, calculating the total cost to the practice includes querying a purchases table having a date/time column, a practice identifier column, a product identifier column, and a quantity column.

In certain exemplary, non-limiting embodiments, the inventory data and the doctor registration data are stored in a common database.

### BRIEF DESCRIPTION OF THE DRAWINGS

FIG. 1 is a high level block diagram of an example communications system.

FIG. 2 is a more detailed block diagram showing one example of a computing device.

FIGS. 3A and 3B are block diagrams that together show one example of a system for obtaining and using outcome information associated with a prescription drug.

FIG. 4 is a flowchart showing one example of a process for obtaining and using outcome information associated with a prescription drug.

FIG. 5 is a screen shot of an example of a login page.

FIG. 6 is a screen shot of an example of a patient dashboard.

FIG. 7 is a screen shot of an example of a healthcare professional dashboard.

FIG. 8 is an example of a drug comparison chart.

FIG. 9 is a screen shot of an example patient entry and prescription application.

FIG. 10 is a screen shot of an example outcome data collection application.

FIG. 11 is a flow diagram showing another example of a process for obtaining and using outcome information associated with a prescription drug.

FIG. 12 is a block diagram showing another example of a system for obtaining and using outcome information associated with a prescription drug.

FIG. 13 is a flow diagram showing an example of a process for payer contracting.

FIG. 14 is a flow diagram showing an example of a process for healthcare provider enrollment.

FIG. 15 is a flow diagram showing an example of a process for patient enrollment.

FIG. 16 is a flow diagram showing an example of a process for prescription fulfillment.

FIG. 17 is an example of a doctor registration form.

FIG. 18 is an example of a prescription/patient registration form.

FIG. 19 is a block diagram showing an illustrative virtual inventory management system.

FIGS. 20A-20C are diagrams showing illustrative data structures for use within the virtual inventory management system of FIG. 19.

FIG. 21A is a flow diagram showing an illustrative sales method for using with the virtual inventory management system of FIG. 19;

FIG. 21B is a flow diagram showing an illustrative purchase method for using with the virtual inventory management system of FIG. 19.

FIG. 21C is a flow diagram showing an illustrative reconciliation method for using with the virtual inventory management system of FIG. 19.

### DETAILED DESCRIPTION OF THE INVENTION

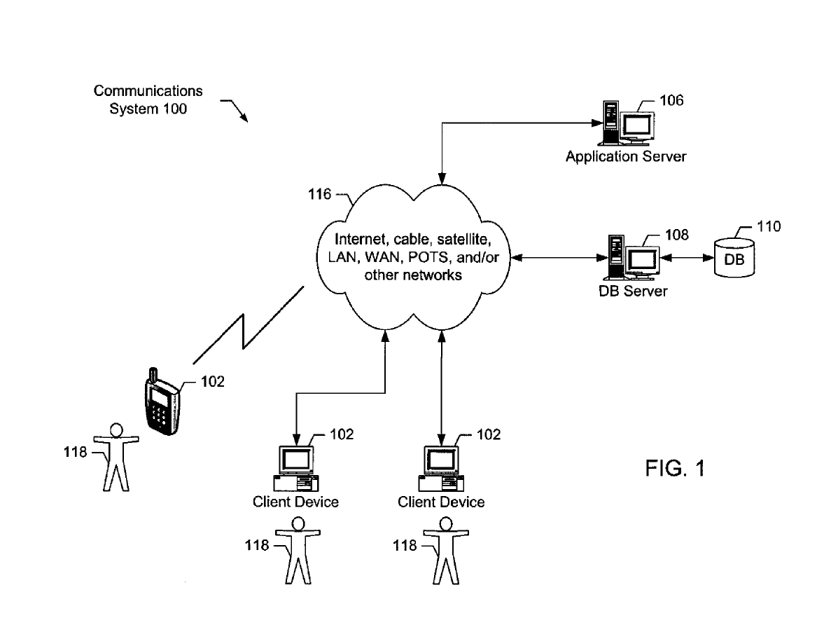

A system according to the instant invention is most readily realized in a network communications system. A high level block diagram of an exemplary network communications system 100 is illustrated in FIG. 1. The illustrated system 100 includes one or more client devices 102, one or more application servers 106, and one or more database servers 108 connected to one or more databases 110.

Each of these devices may communicate with each other via a connection to one or more communications channels 116. The communications channels 116 may be any suitable communications channels 116 such as the Internet, cable, satellite, local area network, wide area networks, telephone networks, etc. It will be appreciated that any of the devices described herein may be directly connected to each other and/or connected over one or more networks.

One application server 106 may interact with a large number of client devices 102. Accordingly, each application server 106 is typically a high end computing device with a large storage capacity, one or more fast microprocessors, and one or more high speed network connections. Conversely, relative to a typical application server 106, each client device 102 typically includes less storage capacity, less processing power, and a slower network connection.

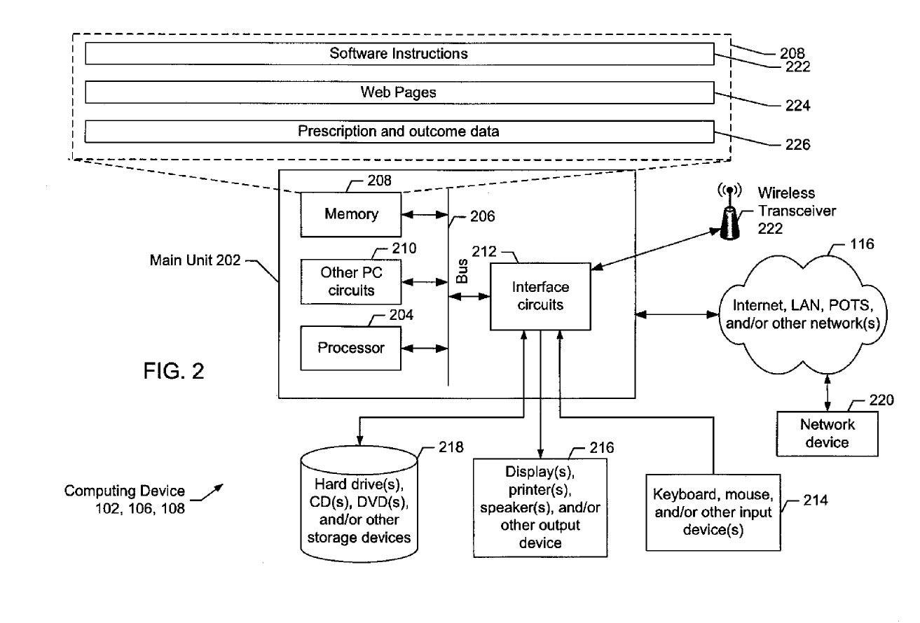

A detailed block diagram of an example computing device 102, 106, 108 is illustrated in FIG. 2. Each computing device 102, 106, 108 may include a server, a desktop computer, a laptop computer, a tablet computer, a personal digital assistant (PDA), a smart phone, and/or any other suitable computing device. Each computing device 102, 106, 108 preferably includes a main unit 202 which preferably includes one or more processors 204 electrically coupled by an address/data bus 206 to one or more memory devices 208, other computer circuitry 210, and one or more interface circuits 212. The processor 204 may be any suitable microprocessor.

Memory 208 preferably includes volatile memory and non-volatile memory. Preferably, memory 208 and/or another storage device 218 stores software instructions 222 that interact with the other devices in the system 100 as described herein. Software instructions 222 may be executed by processor 204 in any suitable manner. Memory 208 and/or another storage device 218 may also store one or more data structures, digital data indicative of documents, files, programs, web pages, etc. retrieved from another computing device 102, 106, 108 and/or loaded via an input device 214.

The example memory device 208 stores software instructions 222, web pages 224, and prescription and outcome data 226 for use by the system as described in detail below. It will be appreciated that many other data fields and records may be stored in memory device 208 to facilitate implementation of the methods and apparatus disclosed herein. In addition, it will be appreciated that any type of suitable data structure (e.g., a flat file data structure, a relational database, a tree data structure, etc.) may be used to facilitate implementation of the methods and apparatus disclosed herein.

Interface circuit 212 may be implemented using any suitable interface standard, such as a Bluetooth interface, an Ethernet interface and/or a Universal Serial Bus (USB) interface. One or more input devices 214 may be connected to interface circuit 212 for entering data and commands into main unit 202. For example, input device 214 may be a keyboard, mouse, touch screen, track pad, track ball, isopoint, and/or a voice recognition system.

One or more displays, printers, speakers, and/or other output devices 216 may also be connected to main unit 202 via interface circuit 212. Display 216 may be a cathode ray tube (CRT), liquid crystal display (LCD), or any other type of display. Display 216 generates visual displays of data generated during operation of computing device 102, 106, 108. For example, display 216 may be used to display web pages received from application server 106. The visual displays may include prompts for human input, run time statistics, calculated values, data, etc.

One or more storage devices 218 may also be connected to main unit 202 via interface circuit 212. For example, a hard drive, CD drive, DVD drive, flash memory drive, and/or other storage devices may be connected to main unit 202. Storage devices 218 may store any type of data used by the computing device 102, 106, 108.

Each computing device 102, 106, 108 may also exchange data with other computing devices 102, 106, 108 and/or other network devices 220 via a connection to the communication channel(s) 116. Communication channel(s) 116 may be any type of network connection, such as an Ethernet connection, WiFi, WiMax, digital subscriber line (DSL), telephone line, coaxial cable, etc. Users 118 of system 100 may be required to register with application server 106. In such an instance, each user 118 may choose a user identifier (e.g., e-mail address) and a password which may be required for the activation of services. The user identifier and password may be passed across communication channel(s) 116 using encryption built into the user's browser, software application, or computing device 102, 106, 108. Alternatively, the user identifier and/or password may be assigned by application server 106.

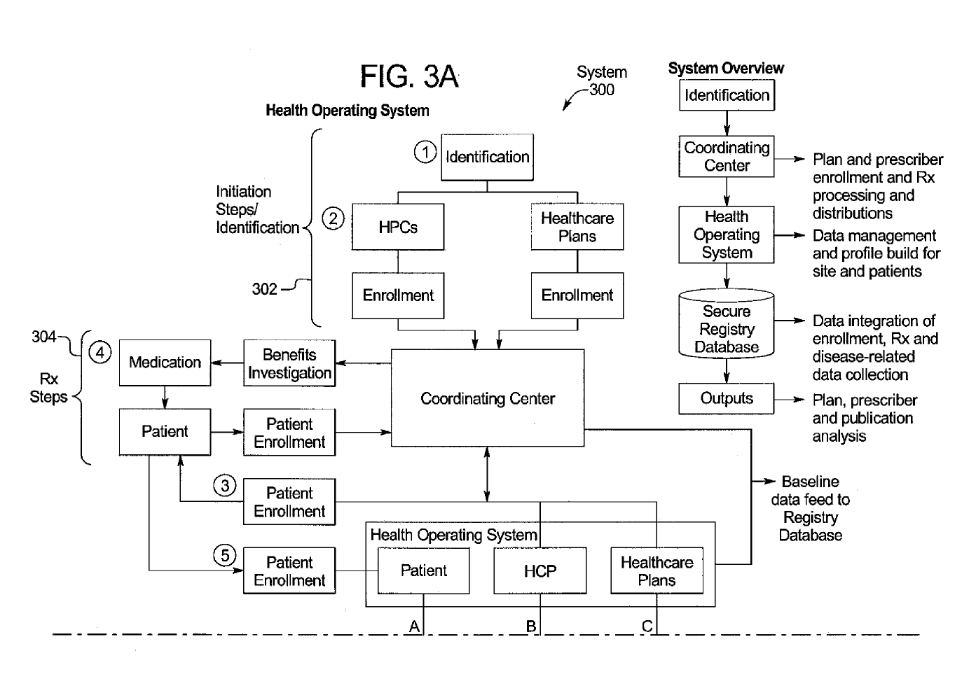

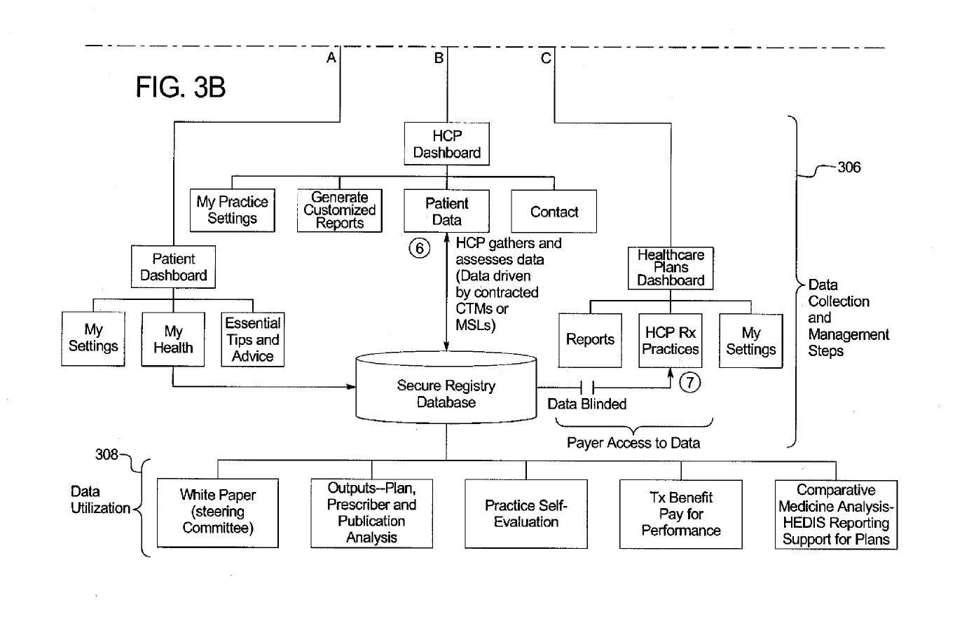

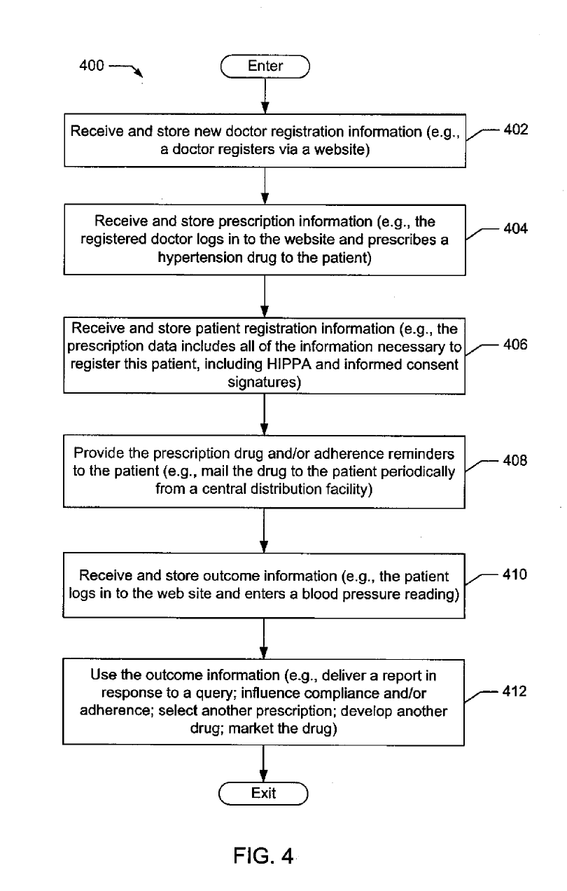

A block diagram showing one example of a system 300 for obtaining and using outcome information associated with a prescription drug (or medical device) is illustrated in FIGS. 3A and 3B. In this example, system 300 includes initiation and identification blocks 302, RX blocks 304, data collection and management blocks 306, and data utilization blocks 308. Each of these sections of system 300 are described briefly here and in more detail below with reference to FIGS. 4-18. Although the examples used herein refer to prescription drugs, a person of ordinary skill in the art will readily appreciate that some or all of these examples also apply to prescribed medical devices such as contact lenses, pace makers, or home hemodialysis machines.

Initiation and identification blocks 302 preferably include identification of health care providers/doctors (HCP) and payers/insurers that may be part of system 300. Payers/insurers may be private and/or public payers/insurers and may include healthcare plans such as for example government plans (e.g., Medicare, Medicaid, Va., etc.), commercial carriers/insurance companies, managed care organizations, health maintenance organizations, preferred provider organizations, high risk insurance pools, special state programs and/or the patient (e.g., cash paying, self insured, uninsured, etc.). System 300 may select (e.g., identify from a database those that meet certain criteria, exclude from a database those that do not meet certain criteria, receive selection input such as selection input manually) certain doctors and/or insurance companies for inclusion in system 300 based on geography, volume, practice type(s) (e.g., specialty, size, etc.), and/or patient populations. For example, practices with a high volume of patients with a certain chronic disease may be selected. Preferably, portion 302 of system 300 includes a streamlined registration process. For example, a doctor may complete an electronic enrollment form and submit the form via a website.

RX blocks 304 preferably include patient enrollment, doctor prescriptions, and drug delivery. For example, a doctor prescribes a drug to a patient, and the patient is thereby registered in the system. For example, a doctor may complete an electronic prescription/patient registration form and submit the form via a website. Alternatively, the doctor may first register the patient in the system before prescribing the drug (e.g., prescription submission via a website). The drug is then provided (e.g., delivered) to the patient. For example, the system may ship (e.g., mail) the drug directly to the patient when requested and/or periodically from a central distribution facility. Alternatively, the system may provide instructions for shipment of the drug from a site (e.g., from a central distribution facility, from manufacturer, from a fulfillment partner, etc.) and/or for shipment of the drug to a site for patient pickup (e.g., doctor's office, on-site pharmacy of healthcare plan clinic). Alternatively, the system may provide instructions for release of the drug (e.g., to the patient directly or shipped) from inventory (e.g., existing inventory) at a pharmacy, such as a retail pharmacy, and/or any suitable fulfillment partner.

Data collection and management blocks 306 preferably include patient monitoring and data dashboards. Prior to initiating treatment with the drug (e.g., baseline) and/or after the patient has taken the drug (e.g., for some period of time), outcome information (e.g., outcome data) is collected. In order to collect the outcome information, the system may provide a data collection device or kit to the patient (e.g., by mail), instructions for shipment of a data collection device or kit to the patient, and/or instructions related to collection of outcome information (e.g., to the patient, to the patient's doctor). For example, if the drug was prescribed for hypertension, the patient may be provided with a blood pressure reading device in order to provide outcome information such as periodic blood pressure readings. Alternatively, or in addition, the patient may need to visit his/her doctor or alternatively a laboratory (e.g., diagnostic laboratory) to collect certain outcome information.

The outcome information may be viewed by the patient, the doctor, and/or the healthcare plan (e.g., in aggregate) via a software dashboard. For example, a patient may log in to a website and view a graph of his/her blood pressure readings. In another example, a doctor may query the system to see what percentage of his/her male patients over thirty years old have a reduced blood pressure after six months on a particular drug prescribed for hypertension. In yet another example, a health care plan and/or a managed care organization may request a report comparing the effectiveness of two different drugs. In another example, a doctor and/or a health care plan and/or a managed care organization may check for compliance (e.g., Does it appear that the patient is taking the drug according to the prescribed dosage and frequency and/or is the prescription being refilled?).

Data utilization blocks 308 include publication of aggregate information (e.g., outcome information), analysis of outcome information, and utilization of the outcome information to achieve one or more results (e.g., drive medical decisions). For example, the outcome information may be used to influence compliance and/or adherence of a prescription drug based. In another example, the outcome information may be used to select a different medical prescription. In another example, the outcome information may be used to market a prescription drug. For example, the outcome information may be used to market a prescription drug by showing a doctor outcome information associated with that drug and/or a competitive drug. In yet another example, the outcome information may be used to develop a new drug.

A flowchart of an example process 400 for obtaining and using outcome information associated with a prescription drug (or medical device) is presented in FIG. 4. Preferably, process 400 is embodied in one or more software programs, which are stored in one or more memories and executed by one or more processors. Although process 400 is described with reference to the flowchart illustrated in FIG. 4, it will be appreciated that many other methods of performing the acts associated process 400 may be used. For example, the order of many of the steps may be changed, some of the steps described may be optional, and additional steps may be included.

In general, process 400 facilitates the registration of doctors and patients in a system (e.g., central prescription distribution system). Once registered, the system may permit and/or facilitate doctors in the system to prescribe drugs to patients, which in turn registers the patients in the system. Alternatively, once registered, the system may permit and/or facilitate doctors in the system to prescribe drugs to patients and register patients in the system during the same submission, or to prescribe drugs to patients already registered in the system (e.g., patients registered previously by the same doctor or a different doctor). Prescribed drugs are provided to the patient, preferably by shipment from one or more distribution hubs directly to the patient. Outcome information associated with prescription drugs provided to patients is then collected (e.g., from the patients) and used in a variety of ways.

More specifically, a system using example process 400 begins by receiving and storing new doctor registration information in a centrally accessible system (block 402). For example, the doctor registration information may be from a doctor completing an electronic registration form and submitting the form to the system via a website or e-mail. Alternatively, the information may be from a doctor completing a paper form and sending the form to the system via facsimile, regular mail, and/or a scanned e-mail attachment. In yet another example, the information may be from a doctor registering via a live telephone operator and/or an automated touch tone system. Preferably, doctor registration in the system (e.g., the submission and storage of the doctor registration information) is not mandated by a government agency such as a government approval agency (e.g., the Food and Drug Administration). In certain embodiments, the majority of doctors or substantially every doctor allowed to prescribe the prescription drug is registered in the system (e.g., greater than or equal to some percentage such as 50%, 60%, 70%, 80%, 90%, or 100%).

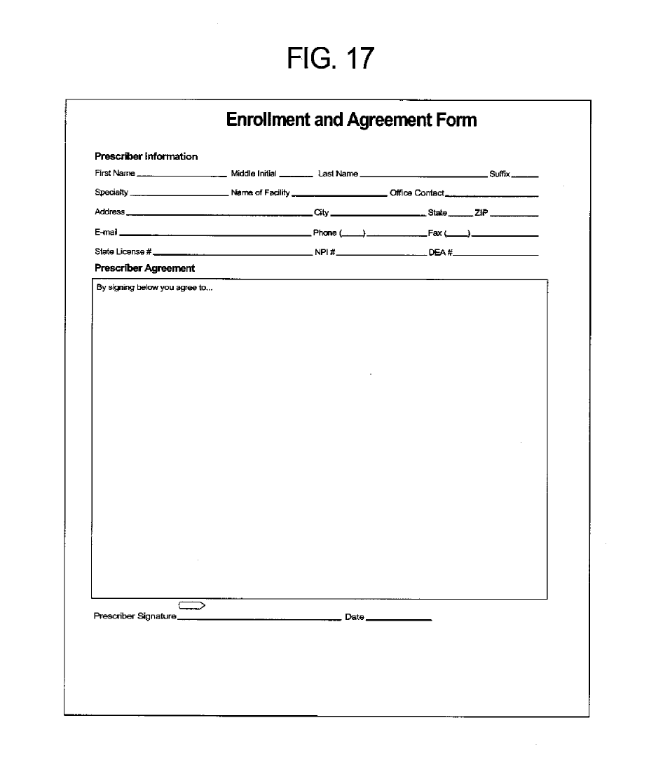

An example of a doctor registration form is illustrated in FIG. 17. As shown, doctor registration information preferably includes some or all of the doctor's name, address, telephone number, fax number, e-mail address, state license number, ME number, DEA number, MPI number, practice area, specialties, etc. In addition, the doctor registration information preferably includes a prescriber agreement and the doctor's signature on that agreement. For example, the doctor may agree to adhere to one or more requirements or regulations of a government agency (e.g., requirements of the Health Insurance Portability and Accountability Act (HIPAA)), to obtain appropriate patient consent (e.g., informed consent), to educate the patient about the side effects of the drug and/or to collect certain outcome information (e.g., MRI data). Some or all of the doctor registration may be selected from a menu and/or manually entered or edited.

Returning to the flowchart in FIG. 4, a system using process 400 receives and stores prescription information (block 404). For example, prescription information may be from a doctor completing an electronic prescription/patient registration form and submitting the form to the system via a website or e-mail. Alternatively, the information may be from a doctor completing a paper form and sending the form to the system via facsimile, regular mail, and/or e-mail attachment. In yet another example, the information may be from a doctor prescribing a drug via a live telephone operator and/or an automated touch tone system.

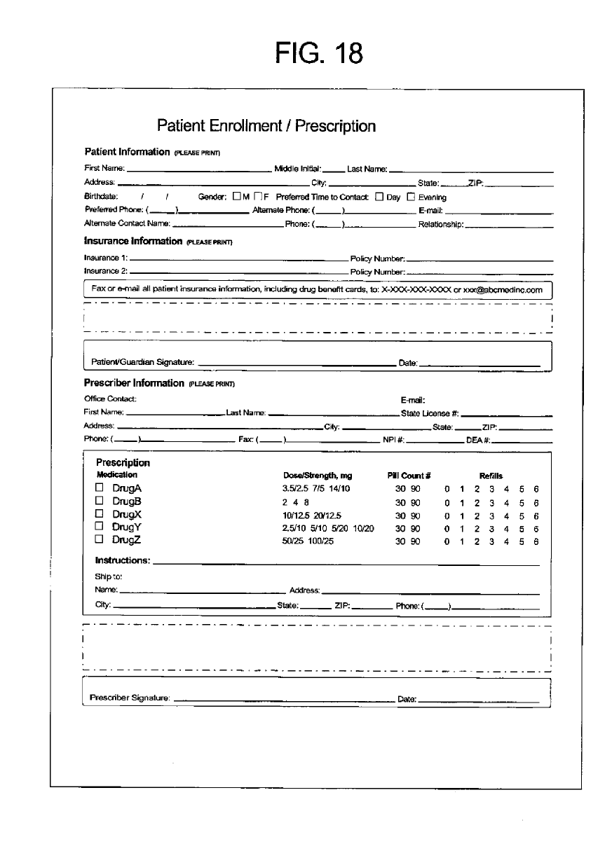

An example of a prescription/patient registration form is illustrated in FIG. 18. As shown, prescription information preferably includes doctor data, patient data, and drug data. Doctor data preferably includes some or all of the doctor registration information, such as the doctor's prescribing number. Patient data preferably includes the patient's name, address, phone number, insurance information, etc. Drug data preferably includes a drug identifier, a dose, and administration instructions.

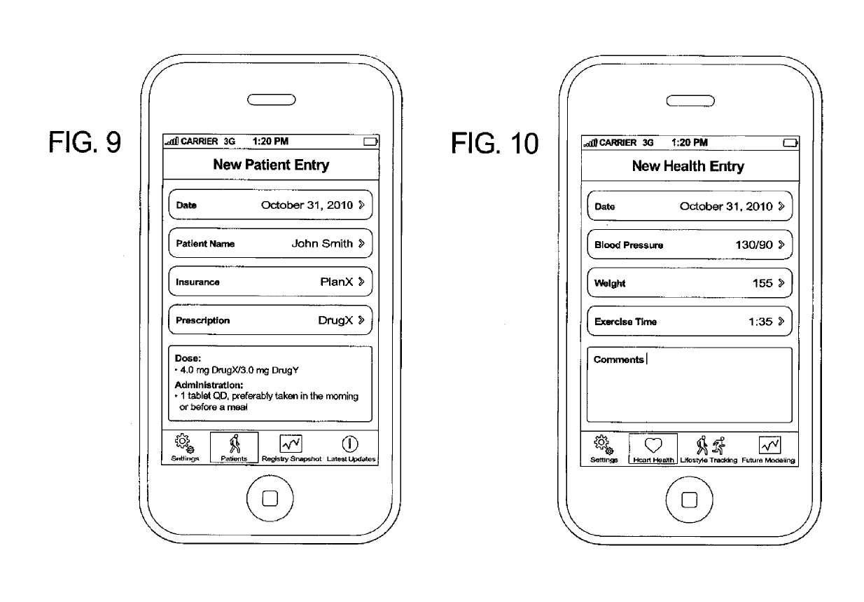

A screen shot of an example prescription application is illustrated in FIG. 9. In this example, the doctor prescribes Drug X to John Smith. Preferably, the system assists the doctor's selections, and some or all of the prescription information may be selected from one or more menus. For example, once a drug is selected, the system preferably limits the dosage choices and/or administration instructions (e.g., consumption frequency) to the dosages and/or administration instructions actually available for that drug. In this example, different patients associated with the registered and/or logged in doctor may be selected from a menu. Similarly, an insurance company may be selected or may be automatically populated from a previous selection for the current patient. Other information associated with the patient may also be entered such as the patient's age, weight, sex, medical history, etc. The patient information is then preferably transmitted over a network to the central system.

Returning to the flowchart in FIG. 4, a system using process 400 also receives and stores patient registration information (block 406). Patient information may be received directly from the doctor. For example, patient information may be included in the transmitted prescription information as described above with reference to FIG. 18. Accordingly, the patient information may be stored when the prescription information is received from the doctor, and the patient need not be pre-registered to use the system. Alternatively, patient information may be received indirectly from the doctor. For example, patient information may be received from a doctor's staff, a hospital, a health care plan (e.g., a health care plan the doctor is affiliated with), a managed care organization (e.g., HMO and/or a managed care organization the doctor is affiliated with), a clinic, an independent third party, etc. Alternatively, the patient information may be in the system from a previous registration (e.g., pre-registered), such as for example patient information received from the same doctor (e.g., for a previous prescription) or a different doctor (e.g., for unrelated treatment). In any of these embodiments, the patient information may be received in the form of electronic medical records.

Preferably, the patient registration information includes HIPPA and informed consent signatures. However, the submission and storage of other patient registration information is not mandated by a government agency such as the FDA. In certain embodiments, the majority of patients or substantially every patient allowed to take the prescription drug is registered in the system (e.g., greater than or equal to some percentage such as 50%, 60%, 70%, 80%, 90%, or 100%).

Like doctors and patients, private and/or public payers/insurers (e.g., health care plans and/or managed care organizations) may also register with the system. For example, health care plan registration information may be from a representative of a health care plan completing an electronic registration form and submitting the form to the system via a website or e-mail. Alternatively, the information may be from a health care plan representative completing a paper form and sending the form to the system via facsimile, regular mail, and/or a scanned e-mail attachment. In yet another example, the information may be from a health care plan representative registering via a live telephone operator and/or an automated touch tone system. Preferably, health care plan registration in the system and/or a managed care organization registration in the system (e.g., the submission and storage of the health care plan registration information) is not mandated by a government agency such as the Food and Drug Administration (FDA). In certain embodiments, the majority of health care plans and/or a managed care organizations, or substantially every health care plan and/or a managed care organization allowed to use the system is registered in the system (e.g., greater than or equal to some percentage such as 50%, 60%, 70%, 80%, 90%, or 100%).

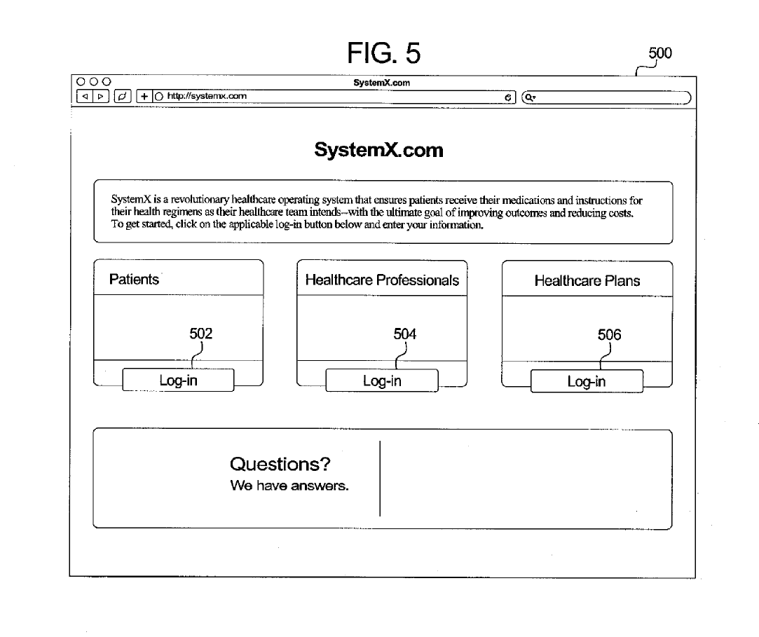

The system may permit and/or facilitate individuals (e.g., patients and/or doctors) or organizations (e.g., medical offices, managed care organizations and/or health care plans) that are registered with the system to access the system to perform certain tasks and review certain data. Preferably, individuals' and organizations' access to the system is by logging in via a web page or web based application. A screen shot of an example login page 500 is illustrated in FIG. 5. In this example, patients′, healthcare professionals′, and healthcare plan providers' access may be by logging in to the system using log in buttons 502, 504, and 506 respectively. Access to the system by individuals and organizations that are registered with the system may also be in any other suitable manner. For example, individuals' or organizations' access to the system may be via facsimile, e-mail, regular mail, and/or touch tone telephone.

The system may permit and/or facilitate patients' access to the system to request prescribed drugs. For example, if a patient's prescription includes one or more refills, the system may permit a patient to log in to the system to request a refill. In such an instance, the system may determine that the request is early and deny or delay the refill. For example, if each fulfillment of the prescription includes a one month supply, and the patient request comes only two weeks after the last fulfillment, the system may determine that the request is too early and deny or delay the refill. In addition, the system may notify the prescribing doctor (e.g., prescriber) of the fulfillment of a prescription and/or any other event, such as denying or delaying a refill. Notifications to patients and doctors may be performed in any suitable manner. For example, the system may send the doctor an e-mail, generate an automated phone message, or simply store the data for later retrieval by the doctor.

Conversely, the system may determine that the request is late and warn the patient and/or the prescriber about compliance. For example, if each fulfillment of the prescription includes a one month supply, and the patient request comes six weeks after the last fulfillment, the system may determine that the request is late and warn the patient and/or notify the prescriber of this event. For example, the system may notify the patient about medical risks associated with not adhering to the prescription and notify the doctor that the patient is not adhering to the prescription. Notifications to patients and doctors may be performed in any suitable manner. For example, the system may send patients and/or doctors an e-mail message, generate an automated phone message, or store the messages for later retrieval by the patients and/or doctors.

Alternatively, an election may be made (e.g., by the patient, by the doctor) to have the system automatically send each refill of a prescription at the correct time based on the amount of the drug previously provided to the patient and the associated administration instructions. For example, if each fulfillment of the prescription includes a one month supply, the system may automatically mail refills or provide instructions to mail refills to the patient's home address every thirty days starting with the initial fulfillment. In this manner, the patient is more likely to fill his/her entire prescription (e.g., all prescribed refills) than in a typical retail environment where a physical visit to a pharmacy may be required. In addition, the patient is more likely to adhere to the prescription, because of the automatic fulfillment.

The system may permit and/or facilitate patients' access to the system to review their own outcome information. For example, if the drug is prescribed for hypertension, the patient may be required to periodically take his/her own blood pressure and enter that data in to the system (as described in detail below). In this example, the patient may be allowed to access the system and review those blood pressure readings. For example, the system may permit the patient to log in to a website and view a graph of his/her blood pressure readings. In another example, the system may read the patient's outcome information over the telephone or send an e-mail message that includes the patient's outcome information.

Returning to the flowchart in FIG. 4, a system using process 400 also provides the prescription drug and/or a reminder to the patient (block 408). For example, the system may mail or provide instructions to mail the drug directly to the patient when requested and/or periodically. Preferably, the prescription drug is not available at retail locations (e.g., no retail locations, limited number of retail locations) via distribution from a manufacturer of the prescription drug and/or a wholesale distributor of prescription drugs.

Preferably, the drug is mailed from a central distribution facility. However, the drug may be mailed from a manufacturer upon request from (e.g., instructions provided by) the system. As described above, the system may permit and/or facilitate patients to access the system (e.g., via a website) and request refills. Alternatively, the system may permit and/or facilitate patients to request automatic refills (e.g., every thirty days) per his/her doctor's prescription.

Alternatively, the drug may be sent to the doctor's office for pick up by the patient. In this manner, the doctor may perform certain follow up education (e.g., regarding diet, exercise, side effects, complications, etc.) for the patient and/or collect certain outcome information (e.g., an MRI). Preferably, the doctor does not keep an inventory of the drug. Instead, the doctor only receives the drug at or about the time the drug is needed for a particular patient.

In yet another alternative, one or more of the drugs provided by the system may be kept in an inventory of a closed health care plan (e.g., health care program, health care network, managed care organization), such as a veteran's affairs plan or health maintenance organization (HMO). In some instances, the closed plan may mail the drug to the patient. In other instances, the patient visits an onsite pharmacy of a clinic associated with the closed plan to pick up the drug. In any case, permission or instructions to distribute the drug to the patient comes from (e.g., originates from) the system (e.g., central distribution system) based on a registered doctor's prescription for that patient.

In addition, the system may send the patient one or more reminders to refill a prescription. For example, the system may send the patient an e-mail or an automated telephone reminder around the time the patient should be refilling their prescription. In certain embodiments, the reminder is sent prior to the normal renewal time prompting the patient to request their refill. In certain embodiments, the reminder is sent after the normal renewal time prompting the patient to request their refill and informing the patient about the risks of not adhering to their prescription.

Once the patient has been taking the prescription drug for a period of time, the system receives certain outcome information (e.g., from the patient and/or the doctor), which is stored in the central system (block 410). The type of outcome information collected is preferably predetermined by the prescribing doctor and/or a steering committee (e.g., a group of doctors that specialize in a certain field of medicine) based on the indicated medical condition associated with the prescription drug. For example, if the drug was prescribed for hypertension, the patient may be provided with a blood pressure reading device in order to provide periodic blood pressure data. If the drug was prescribed for a neurological condition, the patient may be required to periodically visit his doctor for an MRI. Outcome information may be received directly (e.g., as in the examples above) or indirectly from the patient and/or the doctor. For example, outcome information may be received from a doctor's staff, a hospital, a health care plan (e.g., a health care plan the doctor is affiliated with), a managed care organization (e.g., HMO and/or a managed care organization the doctor is affiliated with), a clinic, a third party (e.g., an independent third party including, for example a diagnostic or testing lab), etc. In some instances, the system may permit and/or facilitate a user of the system to encourage and/or require certain types of outcome information to be collected. For example, a health plan and/or a managed care organization may query the outcome information and determine that doctors that collect certain outcome information (e.g., weekly body weight) often show better results (e.g., less heart attacks) for a certain prescription drug than doctors that do not collect that outcome information.

Preferably, this information is periodically collected or received by (e.g., submitted to) the system, such as for example, daily, weekly and/or monthly. For example, a person may periodically visit the participating doctor's offices and/or the outcome information may be electronically transited to the system. Preferably, the submission and storing of the outcome information is not mandated by a government agency such as the FDA.

A screen shot of an example outcome information collection application is illustrated in FIG. 10. In this example, information (e.g., data) for blood pressure, weight and exercise time may be selected from a menu and/or manually entered. Outcome information collection may also be performed via doctor and/or patient dashboards as described in detail below.

Returning to the flowchart in FIG. 4, a system using process 400 may use the outcome information (block 412). For example, the outcome information may be used to generate and/or deliver a report in response to a query via a software dashboard. A query may come from a doctor, a payer, a patient, a government agency, a health care plan, and/or a managed care organization.

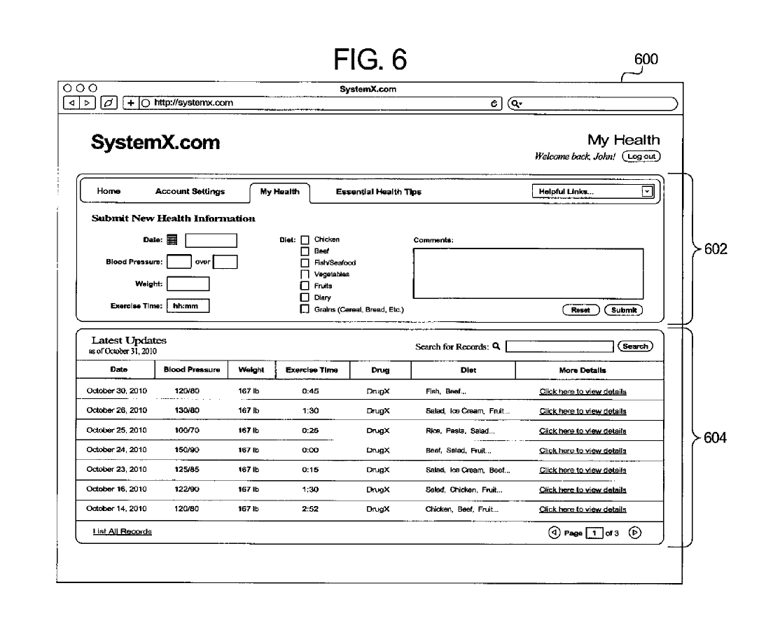

A screen shot of an example patient dashboard 600 is illustrated in FIG. 6. In this example, patient dashboard 600 includes data submission section 602 and data display section 604. Data submission section 602 may be used to enter patient information and/or outcome information. In this example, patient information includes the patient's weight, exercise time, and diet. It will be appreciated that any patient information, such as name, age, sex, ethnicity, other medications, other comorbidities, etc. may be entered via patient dashboard 600. In this example, outcome information includes the patient's blood pressure. It will be appreciated that any outcome information, such as weight, events, pain descriptions etc. may be entered via patient dashboard 600. Depending on the drug and/or indicated condition, certain data may be considered patient information and/or outcome information. For example, if the drug is prescribed for hypertension, weight may be considered patient information. If the drug is prescribed for weight loss, weight may be considered outcome information.

Data display section 604 may be used to display patient information and/or outcome information. In this example, patient information includes the patient's weight, exercise time, drug and diet. It will be appreciated that any patient information, such as name, age, sex, ethnicity, etc. may be displayed via patient dashboard 600. In this example, outcome information includes the patient's blood pressure. It will be appreciated that any outcome information, such as weight, events, pain descriptions etc. maybe displayed via patient dashboard 600. Again, depending on the drug and/or indicated condition, certain data may be considered patient information and/or outcome information (e.g., weight).

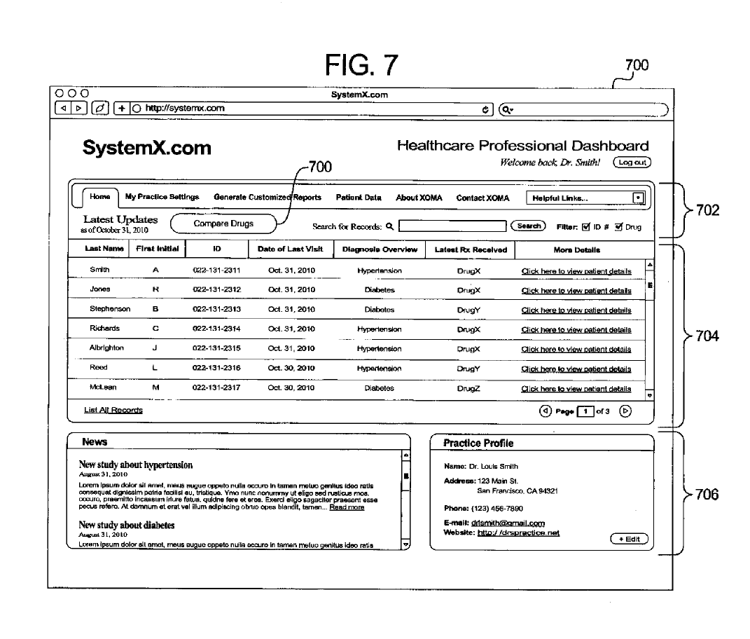

A screen shot of an example health care provider dashboard 700 is illustrated in FIG. 7. In this example, health care provider dashboard 700 includes a query section 702, a data display section 704, and a miscellaneous section 706. Query section 702 may be used to find a patient or run reports using aggregated outcome information from multiple patients. For example, a doctor may want to see what percentage of male patients over thirty years of age have reduced their blood pressure after six months on a particular drug prescribed for hypertension.

In this example, query section 702 includes a compare feature 700. Compare feature 700 allows a doctor to compare the effectiveness of two different drugs. For example, a doctor may want to compare the effectiveness of Drug X to the effectiveness of Drug Y.

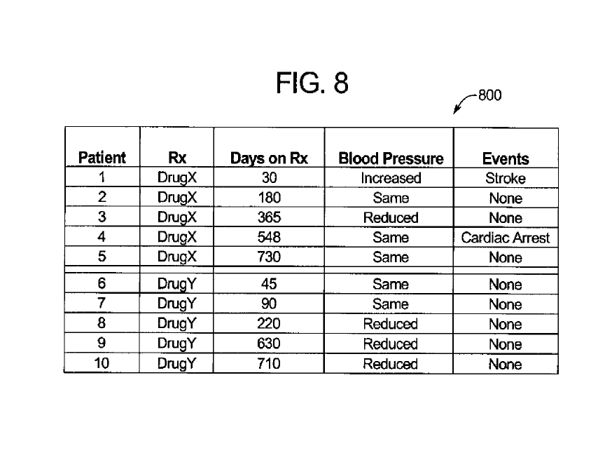

An example of a drug comparison chart 800 is illustrated in FIG. 8. In this example, five patients taking Drug X are compared to five patients taking Drug Y. Drug comparison chart 800 includes patient information and outcome information. The patient information includes a patient identifier (e.g., a patient number), the drug the patient is taking (e.g., Drug X or Drug Y), and the number of days the patient has been taking the drug (e.g., 30 days). If the user is a doctor, the patient identifier may be unique (e.g., name, social security number, etc.), otherwise the patient identifier is preferably generic (e.g., 1, 2, 3, etc.). The outcome information includes the patient's overall blood pressure trend (e.g., decreased), and any events associated with the patient's diagnosed condition (e.g., cardiovascular event, stroke).

Returning to health care provider dashboard 700 illustrated in FIG. 7, example data display section 704 includes a plurality of different patients taking a plurality of different drugs. In this example, each patient is identified by name (e.g., Harris) and identification number (e.g., 022-131-2311).

Patients with the same diagnoses may be taking the same or different drugs. For example, patients Kitteredge, Hampts, and Rondelle are all diagnosed with hypertension. Kitteredge and Hampts are both taking Drug X. However, Rondelle is taking Drug Y. Patients with different diagnoses may also be taking the same or different drugs. For example, patient Harris is diagnosed with hypertension and patient LaRoux is diagnosed with diabetes. However, both Harris and LaRoux are taking Drug X.

Miscellaneous section 706 of health care provider dashboard 700 includes other information such as news and doctor information. In one embodiment, the news is automatically correlated to the diagnoses being displayed. For example, if data display section 704 includes patients diagnosed with hypertension, miscellaneous section 706 may display news about hypertension, such as new hypertension studies, hypertension drugs, tips to decrease cardiovascular risk, etc.

Returning to the flowchart in FIG. 4, a system using process 400 may use the outcome information for purposes other than reporting (block 412). For example, the outcome information may also be used to influence patient compliance and/or adherence. For example, the system may notify the patient about medical risks associated with not adhering to the prescription and/or notify the doctor that the patient is not adhering to the prescription. Evidence of this influence may be numerical. For example, a patient or group of patients may refill prescriptions closer to the prescribed schedule than that patient or group had previously refilled prescriptions. In another example, a group of patients using the system may have a higher percentage of initial fills and/or refills than another group of patients that are not using the system. Similarly, a group of patients taking one or more drugs for a certain indication (e.g., hypertension) using the system may have a higher percentage of initial fills and/or refills than a similar group of patients taking one or more drugs for the same indication (e.g., hypertension) that are not using the system.

Based on comparative reports, the outcome information may be used to select another prescription for a patient. The new prescription may be for a different dose of the same drug, an alternate drug, an additional drug, a different consumption frequency, a different time of day, etc. Similarly, outcome information may also be used to develop another drug. The new drug may have the same and/or different active ingredients as drugs that are studied using the system. The outcome information may also be used to market the drug and/or the system itself. For example, doctors may be receptive to participating in a system that offers evidence-based data and/or increased patient compliance or adherence. In addition, doctors may find comparisons of drugs convincing.

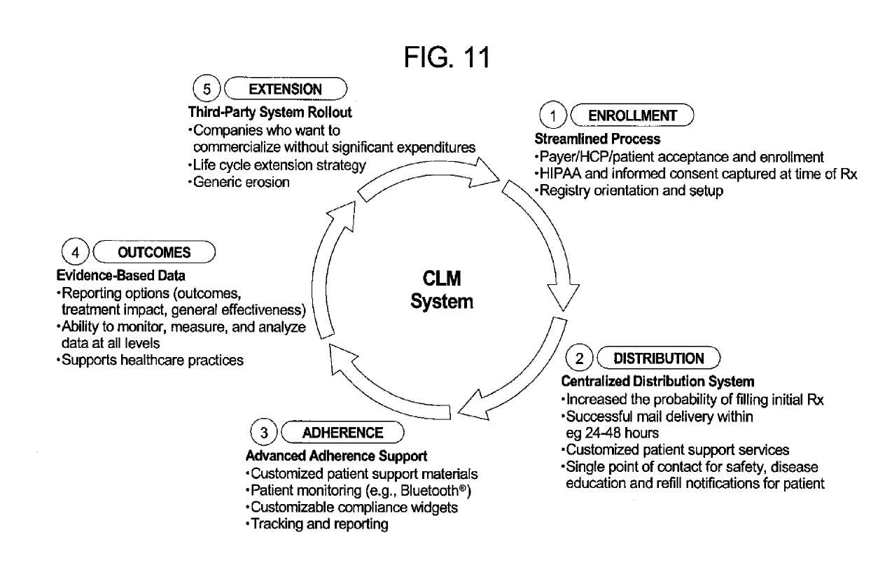

A flow diagram showing another example of a process for obtaining and using outcome information associated with a prescription drug is illustrated in FIG. 11. In this example, the system includes an enrollment phase, a distribution phase, an adherence phase, an outcomes phase, and an extension phase.

The enrollment phase includes a streamlined process for acceptance and enrollment, capture of HIPPA and informed consent, and registry orientation and setup. As described above with reference to blocks 402-404 of FIG. 4, the acceptance and enrollment of payers, health care providers, and patients preferably includes a web based enrollment process, but may include other suitable enrollment processes, such as paper forms. Preferably, the capture of HIPPA and informed consent is accomplished by capturing the patient's signature at the time the prescription is written. For example, the doctor may have the patient sign the necessary forms and the system receives such forms uploaded or attached at the time the doctor submits the prescription. Alternatively, the system may receive from the doctor's submission a statement that he/she has obtained the patient's HIPPA and informed consent, which may be maintained with the doctor's files. Registry orientation and setup is preferably is performed via the software dashboards described above.

The distribution phase may utilize a central distribution system that increases the probability of filing initial prescriptions, delivers the prescribed drug within a short period of time (e.g., 24 to 48 hours), customizes patient support services, and acts as a single point of contact for safety, disease education, and refill notification. As described above with reference to block 408 of FIG. 4, the initial prescriptions are automatically provided (e.g., shipped) directly to the patient in response to a doctor's prescription with no retail middle-man, therefore patients do not have to travel to a pharmacy or submit for alternative prescription fulfillment (e.g., mail order), prices may be reduced, and/or fulfillment percentages increase. Additional benefits may include that patients may be notified of upcoming refills, missed refills, or receive automatic refills.

As described above with reference to blocks 408-410 of FIG. 4, the adherence phase includes customized patient support materials, patient monitoring, compliance widgets, tracking, and reporting. For example, patients may receive an e-mail message, automated phone message, or a message via their dashboard that describes the methods and reasons for adherence to their specific drug. In addition, e-mail, phone and/or dashboard reminders may help the patient adhere to the prescription. As described above, outcome information is collected during this phase. For example, if the drug was prescribed to reduce cholesterol, the patient may be provided with a home cholesterol measurement kit. Alternatively, or in addition, the patient may need to visit his/her doctor to collect certain outcome information (e.g., x-ray).

As described above with reference to block 412 of FIG. 4, the outcomes phase may include evidence-based data for multiple different parties via various reports, treatment impacts, drug effectiveness data, and analysis. For example, the system may permit and/or facilitate a patient to log in to a website and view a graph of his/her body weight over time. The system may permit and/or facilitate a doctor to query the system to see what percentage of his/her female patients under forty years old have a reduced blood pressure after a year on a particular drug prescribed for hypertension. The system may permit and/or facilitate a health care plan and/or a managed care organization to request a report comparing the effectiveness of two different drugs.

The extension phase may include third-party use of the system. For example, certain other companies may want to commercialize one or more prescription drugs using the described system.

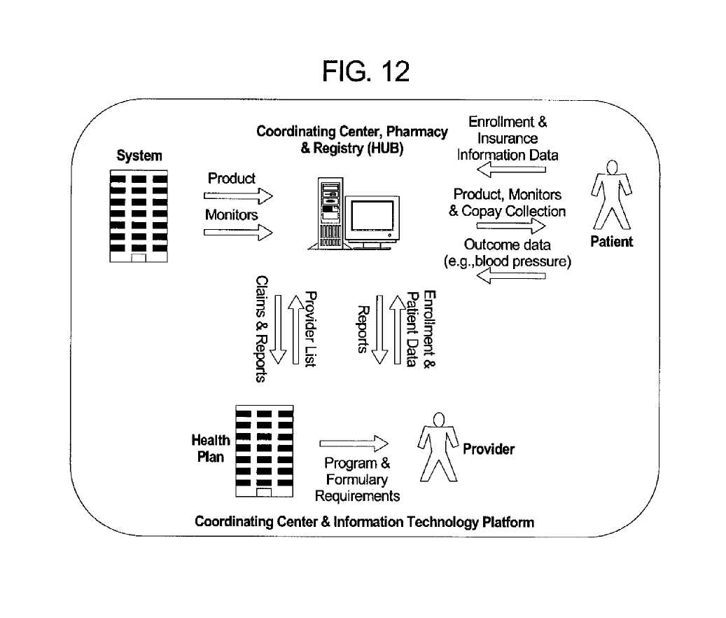

A block diagram showing another example of a system for obtaining and using outcome information associated with a prescription drug is illustrated in FIG. 12. In this example, a central hub is responsible for data collection, shipping drugs (e.g., providing instructions to a third party to ship drugs) and outcome collection devices, verifying patient benefit information, adjudication of insurance claims and/or reporting. The system, which may include the hub, is responsible for providing (e.g., shipping, providing instructions to ship) drugs and outcome collection devices to the patients. The system is also responsible for receiving certain information, such as for example the information from the following individuals and/or organizations. Providers are responsible for enrolling in the program, prescribing to patients, and providing patient data. Health plans, managed care organizations, and/or drug manufactures are responsible for providing a comprehensive provider list to the system (e.g., central registry) and informing providers of program requirements. The patient, the patient's doctor and/or a healthcare plan are preferably responsible for enrolling the patient in the program and providing outcome information at required intervals.

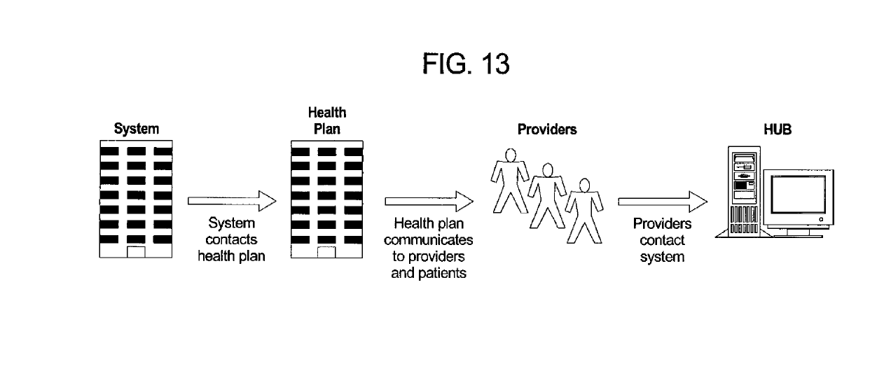

A flow diagram showing an example of a process for payer contracting is illustrated in FIG. 13. In this example, the system contacts one or more health plans and/or a managed care organizations to participate in the program and negotiates discounted pricing on products to ensure preferred formulary status with the health plan and/or a managed care organization. The system permits and/or facilitates the health plan and/or a managed care organization to then communicate to a network of healthcare providers and/or patients informing them of the program requirements and the preferred formulary status. The system permits and/or facilitates the healthcare providers to then contact the system for education and enrollment information in order to prescribe drugs to patients.

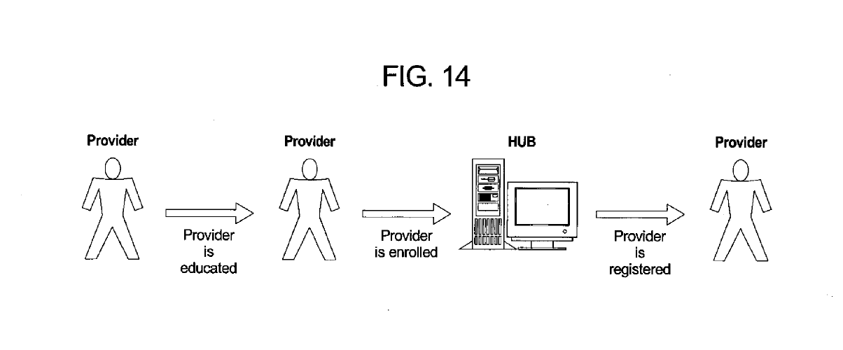

A flow diagram showing an example of a process for healthcare provider enrollment is illustrated in FIG. 14. In this example, a healthcare provider is educated on one or more prescription drugs and the program. The system permits and/or facilitates the healthcare provider to then complete a doctor enrollment form, agreement to participate in the program, and submission of the doctor enrollment form to the system (e.g., via web, fax, or mail). The system then verifies that the submitted information is complete (e.g., includes information in the state license # field) and accurate (e.g., the state license # actually belongs to this doctor). If the information is complete and accurate, the healthcare provider is registered in the system database. Subsequently, the healthcare provider is authorized to write prescriptions for patients, which in turn may enroll those patients in the system, if they are not already registered.

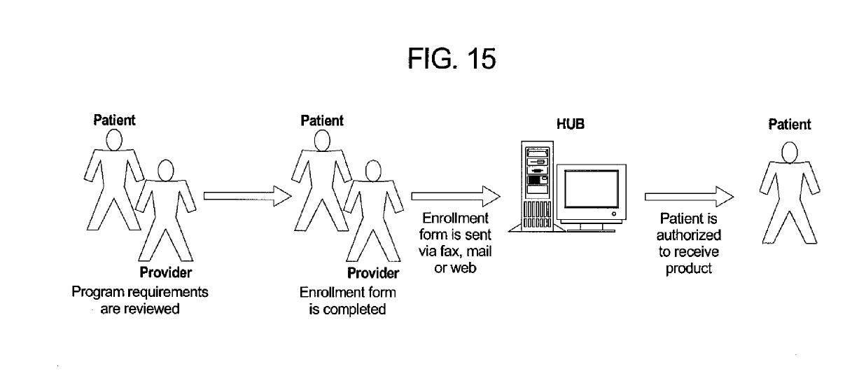

A flow diagram showing an example of a process for patient enrollment is illustrated in FIG. 15. In this example, the system permits and/or facilitates a patient and/or a health care provider to review the program requirements. The system permits and/or facilitates the patient and/or the healthcare provider to then complete a patient enrollment form (which may also include prescription information), agree to participate in the program, and submit the patient enrollment form to the system (e.g., via web, fax, or mail). The system then verifies that the submitted information is complete (e.g., includes information in the address field) and accurate (e.g., the address is current for this patient). If the information is complete and accurate, the patient is registered in the system database. Subsequently (or effectively simultaneously), the patient is authorized to receive prescriptions from doctors enrolled in the system.

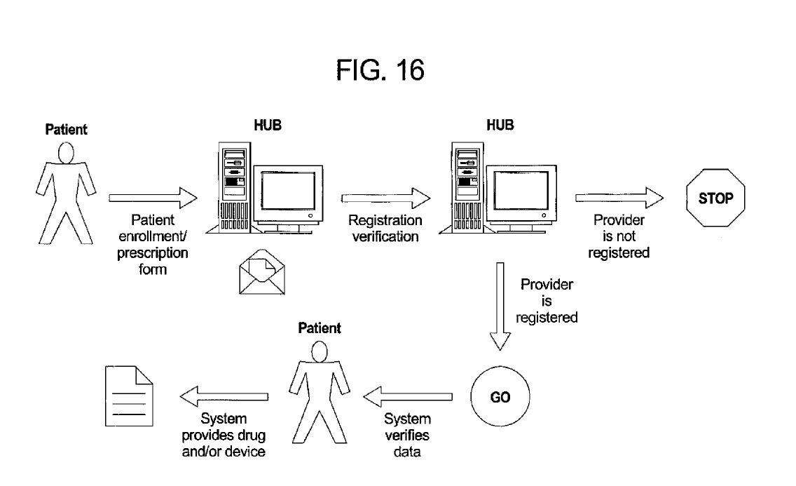

A flow diagram showing an example of a process for prescription fulfillment is illustrated in FIG. 16. In this example, a patient enrollment form and prescription are received by the system. The system verifies the healthcare provider is registered. In addition, the system either registers the patient or verifies the patient was previously registered. If the patient and the provider are both registered in the system, the system optionally performs a benefit investigation and may contact the patient to discuss program requirements and confirm the patient's shipping address. Subsequently, the prescription drug and optionally one or more outcome data collection devices are provided (e.g., shipped) to the patient. In addition, the patient's insurance claim may be processed.

The aforementioned systems and processes may be used for a variety of medical fields and diseases or conditions, such as for example cardiovascular disease (e.g., hypertension, high cholesterol), endocrinology and/or metabolic disease (e.g., Type 2 diabetes, obesity), inflammatory disease and/or rheumatology (e.g., rheumatoid arthritis, osteoarthritis), oncology (e.g., breast cancer, colon cancer), neurologic disease (e.g., Alzheimer's, Parkinson's), gastroenteric disease (e.g., inflammatory bowel disease), autoimmune disease (e.g., Type 1 diabetes, multiple sclerosis), dermatologic disease (e.g., psoriasis, dermatitis), infectious disease (e.g., influenza, hepatitis), ophthalmologic disease (e.g., retinopathy, uveitis), nephrology (e.g., chronic kidney disease), otolaryngology (e.g., otitis media, sinusitis), pulmonary disease (e.g., chronic obstructive pulmonary disease, pulmonary fibrosis), orthopedic disease (e.g., osteoporosis), hematologic disease (e.g., leukemia), allergy (e.g., allergic rhinitis), gynecological disease (e.g., endometriosis), urologic disease and psychiatric disease, and as noted in Table 1 below.

TABLE 1
Medical Conditions

| | | Measurement | |
|---|---|---|---|
| Indicated | | (e.g., device | |
| Medical | Drug | and/or | Outcome |
| Condition | (type) | observation) | information |
| Hypertension | ACE | Blood | Change (e.g., |
| | inhibitor | Pressure | decrease) in |
| | | monitor | blood pressure |
| | | Observation, | Occurrence of a |
| | | blood test, | cardiovascular event |
| | | imaging (e.g., | (e.g., myocardial |
| | | MRI, CT | infarction, stroke, |
| | | scan) | death) |
| Type 2 | DPP-4 | Blood | Change (e.g., |
| diabetes | inhibitor | glucose | decrease) in |
| | | monitor | blood sugar |
| | | Observation, | and/or |
| | | blood test, | HBA1c |
| | | imaging | Occurrence |
| | | (e.g., | of a |
| | | MRI, | cardiovascular |
| | | CT scan) | events (e.g., |
| | | | myocardial |
| | | | infarction, |
| | | | stroke, death) |
| High | Statin | Cholesterol | Change (e.g., |
| cholesterol | | test kit | decrease) |
| | | Observation, | in total |
| | | blood test, | cholesterol |
| | | imaging | Occurrence |
| | | (e.g., | of a |
| | | MRI,) | cardiovascular |
| | | CT scan | event |
| | | | (e.g., myocardial |
| | | | infarction, |
| | | | stroke, death) |
| Alzheimer’s | Cholinesterase | Imaging | Change (e.g., |
| disease | inhibitor | (e.g., MRI, | delay) |
| | | CT scan) | in worsening |
| | | | of condition |
| Rheumatoid | TNF-alpha | X-ray | Change (e.g., |
| arthritis | inhibitor | | improvement, |
| | | | delay in worsening) |
| | | | in joint |
| Breast cancer | Taxane | Radiologic | Change (e.g., |
| | | assessment | increase) in tumor |
| | | | response rate |
| Chronic | Beta-2 | Self- | Change (e.g., |
| obstructive | agonist | evaluation | improvement) in |
| pulmonary | | | exercise persistence |
| disorder | | | and/or shortness of |
| (COPD) | | | breath |
| Atopic | Corticosteroid | Self- | Change (e.g., |
| dermatitis | | evaluation | improvement) in |
| | | | skin condition |
| Pain | NSAIDS | Quality of | Patient observation |
| | | life survey | of pain; Change |
| | | | in quality |
| | | | of life score |

### Membership Fee Model

In certain embodiments, systems of the instant invention may be based on a membership fee model in which, for example, the patient pays a recurring fee for services. The fee may be fixed or variable based on the services received, and may be processed automatically at regular intervals (e.g., monthly) using patient payment information stored in the system. In exchange for payment of the recurring monthly fee, the patient will, for example, receive direct delivery of all prescribed medications and associated monitoring devices; will have full access to call center and logistical support; and will receive a certain number of virtual office visits with the doctor. In certain embodiments, the monthly membership fee will include a standard allocation of virtual office visits with the doctor, which the patient may increase by paying an additional fee. As will be apparent to those of skill in the art from the teachings provided herein, the membership fee model may be structured to meet each patient's individualized healthcare needs.

Moreover, the membership fee model may operate without a third party payer (such as an insurance company) where the patient pays the entire cost of services; or it may operate with a third party payer, such that the patient pays a recurring monthly fee and the insurance company pays the remainder due for the provided services.

In a membership fee model, patient dashboard 600 (FIG. 6) may include a payments/billing section wherein the patient can add or change their automatic payment information (e.g., credit card details and billing address), schedule future payments, view payment history, and/or cancel automatic payments. The automatic payment information is stored in a database and sensitive information is encrypted using a trusted encryption system (e.g., Triple DES).

The system may also generate invoices at a regular intervals, which may be sent to the patient via regular mail and/or e-mail. Patient dashboard 600 (FIG. 6) includes a section wherein the patient can make a one-time electronic payment (e.g., using a credit card, bank card, or any other type of electronic transfer). The user may choose to have their payment information securely stored in a database for later use.

### Virtual Office Visits

In certain embodiments, a system of the instant invention provides virtual office visits whereby registered physicians can interact with registered patients using, for example, a secure web application. A graphical user interface (GUI) is rendered at each of the doctor and patient's client devices such that text entered in a text input area of the doctor's GUI is displayed in the text display area of the patient's GUI, and vice versa, thereby allowing the doctor and patient to communicate in real-time or near real-time.

The virtual office visit application used for this purpose may be, for example, a web-based application which includes a physician interface integrated into provider dashboard 700 (FIG. 7) and a patient interface integrated into patient dashboard 600 (FIG. 6). The physician interface may include controls by which a physician can allot certain office hours (e.g., a block of time, repeated certain days of each week) with the system; and may further include a calendar-based interface which a physician can use to view scheduled appointments. The patient interface may include an appointment request feature whereby a patient can request a virtual appointment using, for example, a calendar-based interface which displays available time slots based on a selected physician's allotted office hours and previously scheduled appointments. A physician or a physician's assistant may also use a similar interface to schedule an appointment on behalf of a registered patient.

Both the physician and patient virtual office visit interfaces may include real-time communications features, such as a text-based chat feature, a teleconferencing feature, a video conferencing feature, and a document sharing feature. The system may track a physician's time spent conducting virtual office visits, and may use this tracking information to reimburse the physician for the services. The virtual office visits may also be archived for later access by physician and/or patient. As will be apparent to those of skill in the art, virtual office visits in the instant invention may be designed to provide a level of doctor-patient interaction suitable to meet each patient's individualized healthcare needs.

### Virtual Inventory

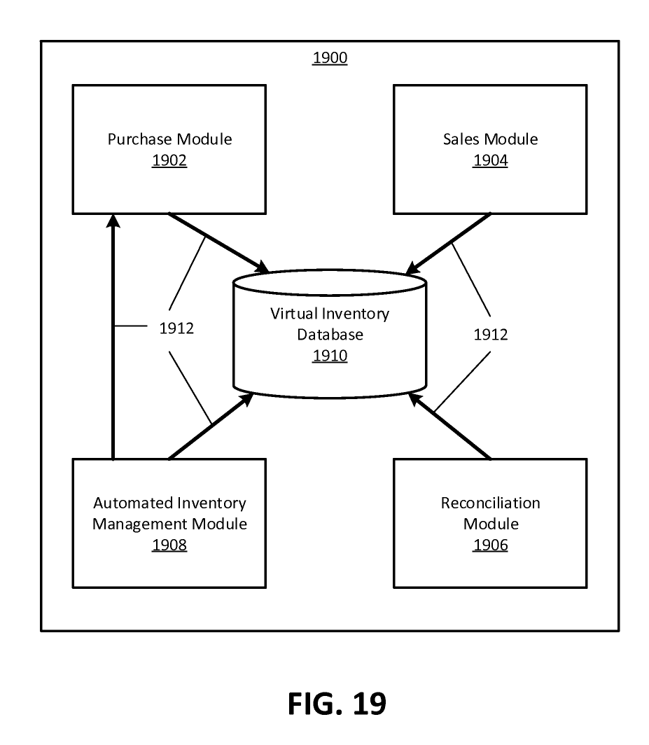

Referring to FIG. 19, an illustrative virtual inventory management system 1900 allows practices (e.g., doctors offices) to maintain a virtual inventory of commonly prescribed products (e.g., drugs and medical devices). Virtual inventory system 1900 may form part of system 300 of FIGS. 3A and 3B and/or be operatively coupled thereto. Virtual inventory management system 1900 includes a plurality of modules (here, modules 1902-1908) operatively coupled to virtual inventory database 1910 via communication channels 1912. A communication channel 1912 can represent any suitable type of communications channel, such as the Internet, cable, satellite, local area networks, wide area networks, telephone networks, etc. It will be appreciated that any of the modules, databases, and devices described herein may be directly connected to each other and/or connected over one or more networks.

In a particular embodiment, system 1900 is realized in a network communications system, such as network communications system 100 described above in conjunction with FIG. 1. Accordingly, modules 1902-1908 may correspond to functionality provided within one or more application servers (e.g., application server 106 in FIG. 1) and virtual inventory database 1910 may correspond to a database server coupled to one or more databases (e.g., database server 108 and database 110 in FIG. 1).

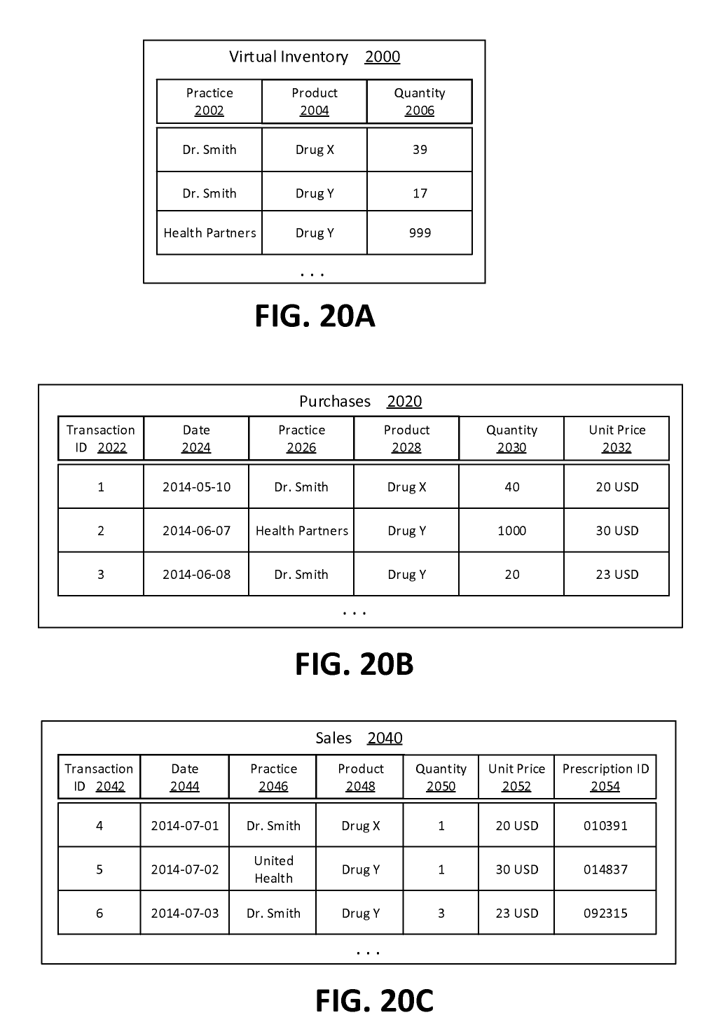

Virtual inventory database 1910 may include any suitable type of database and/or utilize any suitable databases system. In certain embodiments, virtual inventory database 1910 comprises a relational database having a plurality of tables (or “relations”), such as the illustrative tables shown in FIGS. 20A-20C described below. In a particular embodiment, virtual inventory database 1910 forms part of the database used by system 300 of FIGS. 3A and 3B.

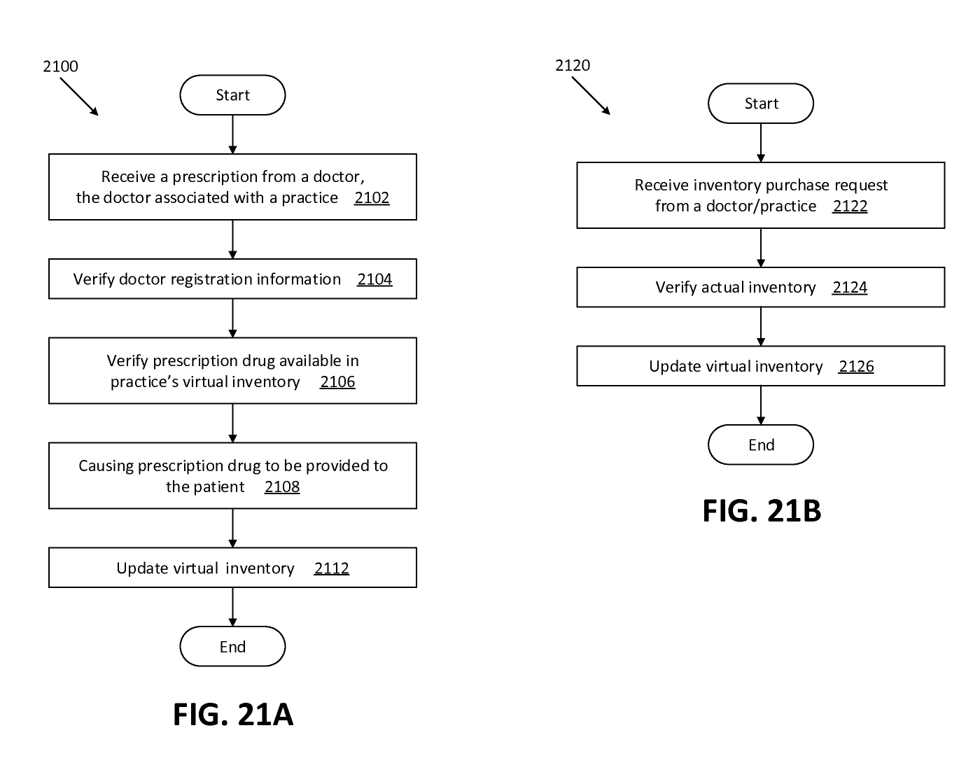

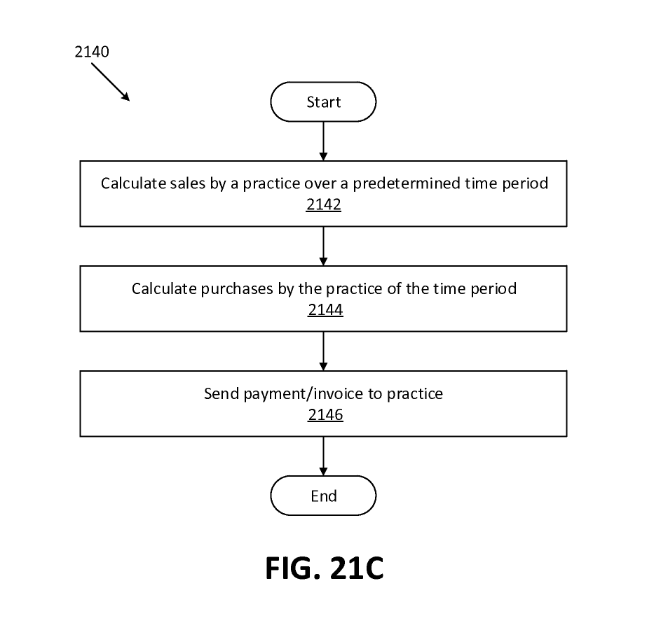

As shown, illustrative virtual inventory management system 1900 includes a purchase module 1902, a sales module 1904, a reconciliation module 1906, and an automated inventory management module 1908. Although the operation of modules 1902-1908 is described in detail below in conjunction with FIGS. 20A-20C and 21A-21C, a brief overview is given herein.

Purchase module 1902 is used to add product to a practice's virtual inventory. Such transactions are referred to as a purchases, although it should be understood that the practice does not take possession of the purchased product, but rather the product is stored in a central distribution facility, pharmacy, or the like. Purchase module 1902 may include a user interface (UI) for use by doctors, nurses, administrative staff, or other authorized persons associated with the practice. In certain embodiments, the virtual inventory purchase UI forms part of health care provider dashboard 700 of FIG. 7.

Sales module 1904 is used to update a practice's virtual inventory to indicate that a certain quantity of a product has been sold by the practice. In certain embodiments, sales module 1904 verifies the virtual inventory levels to determine if the indicated quantity of the product is available. It should be understood that the term “sale” used herein may correspond to several different types of events within system 300 (FIGS. 3A and 3B). For example, referring to the illustrative process 400 of FIG. 4, receiving and storing prescription information in system 300 (block 404) may constitute a sale. As another example, providing a prescription drug to a patient (block 408) may constitute a sale. If the system 300 periodically provides a drug to a patient (either automatically or at the patient's request), each such “refill” may constitute a sale.

In a particular embodiment, products are automatically added to a practice's inventory when they are sold/prescribed. Thus, a practice does not need to explicitly purchase products.

Reconciliation module 1906 is used to periodically reconcile a practice's current virtual inventory with the practice's purchases and sales. Reconciliation module 1906 may handle generating and sending payments/invoices. In certain embodiments, practices are invoiced (or “billed”) on Net basis (e.g., Net 30 days, 60 days, 90 days, etc.), whereby invoices are generated periodically and the total outstanding amount on an invoice is expected to be paid in full within 30, 60, or 90 days after the products are sold to the practice. In certain embodiments, reconciliation occurs every 30 days. Any profit realized by selling a prescription drug to a patient (i.e., the cost to the patient less the cost to the practice) may be provided in full or in part to the practice.

An automated inventory management module 1908 is optionally provided to automatically replenish a practice's virtual inventory. In certain embodiments, automated inventory management module 1908 automatically purchases a given quantity of a product on behalf of a practice if the practice's virtual inventory falls below a certain predetermined quantity. Alternatively, module 1908 may generate and alerts/reminders for the practice based on inventory levels. In certain embodiments, automated inventory management module 1908 uses purchase module 1902 to effect the purchase.

It should be appreciated that, because all prescribed products are stored and shipped from a central distribution facility, practices using the virtual inventory system 300 do not bear risks normally associated with storing and shipping prescription drugs, medical devices, etc.

FIGS. 20A-20C show exemplary data structures for use within virtual inventory system 1900. The data structures may be used by an application program (e.g., one or more of modules 1902-1908 of FIG. 19) and/or within a database system. In certain embodiments, the data structures of FIGS. 20A-20C corresponds to portions of a database schema within virtual inventory database 1910 (FIG. 19). In FIGS. 20A-20C, the data structures are shown to be tables, each having a plurality of columns and rows. The rows correspond to tuples, each having a respective set of attributes, with the columns corresponding to attributes. Although the data structures are shown to be tables and referred to as such herein, it should be understood any other suitable types of data structures may be used, including objects, lists, hashes, trees, etc. The attributes (i.e., columns) shown with each data structure are not meant to be exhaustive. Those skilled in the art will understand that it may be desirable to include additional attributes for ease of implementation, to improve efficiency, and/or to provide additional functionality. In addition, the rows shown in FIGS. 20A-20C are merely a few examples to aid understanding of the systems and techniques sought to be protected herein; in general a table includes an arbitrary number of rows.

Referring to FIG. 20A, an illustrative data structure 2000 can be used to maintain virtual inventories within system 1900 of FIG. 19, and is therefore referred to herein as a “virtual inventory table.” A row in table 2000 corresponds to an available quantity of a certain product within a practice's virtual inventory. Accordingly, the illustrative virtual inventory table 2000 includes a practice column 2002 to identify the practice, a product column 2004 to identify the product, and a quantity column 2006 to indicate the quantity. The practice and product identifiers can be any suitable data types (e.g., strings, integers, etc.). It is assumed that a practice has none of a given product if no corresponding row exists in table 2000. In certain embodiments, the practice and product columns 2002 and 2004 are jointly unique within the table 2000; this constraint may be imposed by an application program and/or a database system.

It will be appreciated that the virtual inventory table 2000 can be used to query (e.g., using SQL) the total quantity of a given product available across all virtual inventories within the system 1900. Such total quantities can be used to reconcile virtual inventory levels with actual (physical) product inventory levels. For example, system 1900 (FIG. 19) may validate that the total virtual inventory for a certain product does not exceed the actual inventory for that same product within a central distribution facility. Such validation may occur during a purchase transaction, as described above in conjunction with FIG. 19. Alternatively, if a product can be provided “on demand” from the manufacturer, system 1900 may use a more relaxed inventory validation policy.

Referring to FIG. 20B, an illustrative data structure 2020 can be used to track purchases within virtual inventory system 1900 of FIG. 19, and is therefore referred to herein as a “purchases table.” A row within table 2020 corresponds to a purchase of a certain quantity of product by a practice. Accordingly, the illustrative purchases table 2020 includes a date column 2024 to identify the date/time of purchase, a practice column 2026 to identify the practice, a product column 2028 to identify the product, a quantity column 2030 to indicate the quantity, and a unit price column 2032 to indicate the per-unit cost to the practice. In certain embodiments, purchases table 2020 also includes a transaction ID column 2022 to uniquely identify the purchase. The transaction ID may be used for auditing purposes and may be omitted in certain embodiments. The practice and product identifiers used within purchases table 2020 may be the same as or similar to those used within virtual inventory table 2000 of FIG. 20A. In certain embodiments, purchase module 1902 (FIG. 19) inserts rows to purchases table 2020 in response to purchase requests.

Referring to FIG. 20C, an illustrative data structure 2040 can be used to track sales within virtual inventory system 1900 of FIG. 19, and is therefore referred to herein as a “sales table.” A row within the sales table 2040 corresponds to a sale of a certain quantity of product by a practice to a patient. Accordingly, the illustrative sales table 2040 includes a date column 2044 to identify the date/time of sale, a practice column 2046 to identify the practice, a product column 2048 to identify the product, a quantity column 2050 to indicate the quantity, and a unit price column 2052 to indicate the per-unit cost to the patient. In certain embodiments, sales table 2040 also includes a transaction ID column 2042 to uniquely identify the purchase. The transaction ID may be used for auditing purposes and may be omitted in certain embodiments. In various embodiments, sales table 2040 includes one or more columns to identify a patient and/or a prescription associated with the sale, e.g., the sales table may include a prescription ID column 2054, as shown; such information may be used for compliance and/or accounting purposes. The practice and product identifiers used within sales table 2040 may be the same as or similar to those used within the virtual inventory table 2000 of FIG. 20A and/or the purchases table 2020 of FIG. 20B. In certain embodiments, sales module 1904 (FIG. 19) inserts rows to sales table 2040 in response to sales requests (e.g., in response to a physician generating a prescription).

FIGS. 21A-21C are flowcharts showing illustrative processes for use within system 300 (FIGS. 3A and 3B) and/or within virtual inventory system 1900 (FIG. 19). The processes may be embodied in one or more software programs, which are stored in one or more computer memories and executed by one or more computer processors. Although the processes are described with reference to the flowcharts of FIGS. 21A-21C, it will be appreciated that many other methods of performing the acts associated with processes may be used. For example, the order of many of the steps may be changed, some of the steps described may be optional, and additional steps may be included.

Referring to FIG. 21A, an illustrative sales process 2100 begins at block 2102 where a prescription is received from doctor associated with a practice. The prescription includes any required patient registration information. At block 2104, the doctor's registration information is verified. At block 2106, a determination is made as to whether the prescribed drug is available within the practice's virtual inventory. This may include querying virtual inventory table 2000 (FIG. 20A). If the prescribed drug is not available, sales process 2100 may be aborted. Alternatively, the sales process may proceed and system 1900 generates a warning. In certain embodiments, the verification of block 2106 is omitted. In a particular embodiment, the prescribed drug is automatically purchased into the practice's virtual inventory as needed. At block 2108, the prescribed drug is provided to the patient and, at block 2112, the practice's virtual inventory is updated to reflect the sale to the patient. In a particular embodiment, block 2112 includes inserting a row into sales table 2040 (FIG. 20C) and/or updating virtual inventory table 2000 (FIG. 20A).

It should be appreciated that at least a portion of the illustrative process 2100 may be implemented within virtual inventory system 1900 (FIG. 19) and, more particularly, within sales module 1904. Furthermore, it is understood that process 2100 may correspond to processing performed by one or more of the steps of process 400, described above in conjunction with FIG. 4.

Referring to FIG. 21B, an illustrative sales process 2120 begins at block 2122 where a purchase request is received. The request, which is associated with a practice, indicates a certain quantity of a product to be purchased. The request may correspond to a user action (e.g., a doctor using health care provider dashboard 700 of FIG. 7) and/or automated processing within virtual inventory system 1900 (e.g., an automatic inventory renewal generated by automated inventory management module 1908). In certain embodiments (block 2124), a determination is made whether actual inventory levels support the purchase and, if not, the purchase request may be aborted. At block 2126, the practice's virtual inventory is updated to reflect the purchase; this may include inserting a row into purchases table 2020 (FIG. 20B) and/or updating virtual inventory table 2000 (FIG. 20A). It should be appreciated that the illustrative process 2100 may be implemented within virtual inventory system 1900 (FIG. 19) and, more particularly, within purchase module 1902.

Referring to FIG. 21C, an illustrative reconciliation process 2140 begins at block 2142, where total sales by a practice over a predetermined time period (e.g., the past 90 days) are calculated. At block 2144, the total purchases by the practice over the same time period are calculated. In certain embodiments, blocks 2142 and 2144 include querying sales table 2040 (FIG. 20C) and purchases table 2020 (FIG. 20B), respectively. Using the total sales and total purchases amounts, the payment or invoice is generated (block 2146) to the practice. In certain embodiments, any non-negative difference between the total cost to patients and the total cost to the practice is paid back to the practice as profit, in full or in part.

Once given the above disclosure, many other features, modifications, and improvements will become apparent to the skilled artisan. Such features, modifications, and improvements are therefore considered to be part of this invention, without limitation imposed by the example embodiments described herein. Moreover, any word, term, phrase, feature, example, embodiment, or part or combination thereof, as used to describe or exemplify embodiments herein, unless unequivocally set forth as expressly uniquely defined or otherwise unequivocally set forth as limiting, is not intended to impart a narrowing scope to the invention in contravention of the ordinary meaning of the claim terms by which the scope of the patent property rights shall otherwise be determined. All references discussed and disclosed herein are hereby incorporated by reference in their entirety.

All references cited are specifically incorporated by reference in their entirety. The citation of references herein shall not be construed as an admission that such is prior art to the instant invention.

What is claimed is:

1. A computer-implemented method of prescribing and distributing a prescription drug to a patient and for monitoring and tracking said patient's response to use of said prescription drug, said method comprising the steps of:
(a) electronically receiving and storing, in a database, data concerning an indicated medical condition;
(b) electronically receiving and storing, in a database, data concerning a prescription drug indicated for use treating said indicated medical condition;
(c) electronically receiving and storing, in a database, one or more outcome data types pre-selected by one or more medical professionals; said one or more outcome data types being associated in said database with said indicated medical condition and said prescription drug; said one or more outcome data types correlating the effect of use of said prescription drug by a patient diagnosed with said indicated medical condition to the treatment of said indicated medical condition in said patient;
(d) electronically receiving and storing, in a database, data concerning an outcome information monitoring device; said outcome information monitoring device being capable of obtaining patient outcome information corresponding to said one or more outcome data types;
(e) electronically receiving doctor registration data from a doctor, and storing said doctor registration data in a database; said doctor registration data including information concerning said doctor and an associated practice;
(f) electronically receiving patient registration data from at least one of said doctor and said patient, and storing said patient registration data in a database; said patient registration data including information concerning said patient;
(g) electronically receiving patient payment information from said patient, and storing said patient payment information in a database;
(h) electronically processing a patient payment using said patient payment information of step (g);
(i) electronically receiving prescription data from said doctor, and storing said prescription data in a database; said prescription data including information concerning said patient, said patient's indicated medical condition and said prescription drug indicated for use in treating said patient's indicated medical condition;
(j) electronically verifying that doctor registration data is stored in said database of step (e) for said doctor providing said prescription data of step (i);
(k) updating inventory data stored in a database; said inventory data associated with said practice and said prescription drug; said inventory data including an available quantity of said prescription drug; wherein updating said stored inventory data includes decreasing said available quantity of said prescription drug;
(l) after processing said patient payment in step (h) and verifying said doctor registration data in step (j), causing said prescription drug to be provided to said patient as indicated by said patient's patient registration data stored in said database of step (f); said prescription drug being provided directly to said patient from a single prescription drug fulfillment source one or a plurality of times, as indicated by said prescription data stored in said database of step (i);
(m) causing an outcome information monitoring device to be provided to said patient based on said outcome information monitoring device data stored in said database of step (d);
(n) electronically receiving fulfillment data, and storing said fulfillment data in a database; said fulfillment data including information concerning fulfillment of said prescription drug by said single prescription drug fulfillment source of step (1); and
(o) electronically receiving, from said patient, patient outcome information corresponding to said one or more outcome data types and obtained by said outcome information monitoring device provided to said patient in step (m), and storing said patient outcome information in a database;
said steps (a)-(o) being implemented in a computer system comprising one or more processors configured to execute one or more computer programs; and
said fulfillment data and said patient outcome information being available to said doctor through one or more electronic interfaces of said computer system.

2. A computer-implemented method according to claim 1, further comprising the step of electronically verifying the availability of said prescription drug based upon said available quantity within said stored inventory data.

3. A computer-implemented method according to claim 1, further comprising the steps of:
electronically receiving an inventory purchase request, said inventory purchase request including information concerning said practice, said prescription drug, and a quantity of said prescription drug; and
in response to receiving said inventory purchase request, updating said stored inventory data to increase said available quantity of said prescription drug.

4. A computer-implemented method according to claim 3, further comprising the step of electronically verifying that said requested quantity of said prescription drug is available in an actual inventory.

5. A computer-implemented method according to claim 1, further comprising the steps of:
calculating a total cost to patients of prescription drugs prescribed by said practice within a predetermined time period;
calculating a total cost to said practice of said prescribed prescription drugs; and
causing a payment to be made to said practice; said payment being an amount based upon said total cost to said patients and the said total cost to said practice.

6. A computer-implemented method according to claim 4, wherein said predetermined time period is a previous 30 day time period.

7. A computer-implemented method according to claim 4, wherein said predetermined time period is a previous 90 day time period.

8. A computer-implemented method according to claim 1, further comprising the steps of:
calculating a total cost to said practice of prescription drugs prescribed by said practice within a predetermined time period; and
causing an invoice to be sent to said practice; said invoice including an amount based upon said total cost to said practice.

9. A computer-implemented method according to claim 8, wherein said predetermined time period is a previous 30 day time period.

10. A computer-implemented method according to claim 8, wherein said predetermined time period is a previous 90 day time period.

11. A computer-implemented method according to claim 1, wherein said prescription drug is provided from a central distribution facility.

12. A computer-implemented method according to claim 1, wherein said stored inventory data comprises:
a purchases table having a date/time column, a practice identifier column, a product identifier column, and a quantity column; and
a sales table having a date/time column, a practice identifier column, a product identifier column, and a quantity column.

13. A computer-implemented method according to claim 12, wherein said stored inventory data further comprises a virtual inventory table having a practice identifier column, a product identifier column, and a quantity column.

14. A computer-implemented method according to claim 1, wherein updating said stored inventory data comprises inserting a row into a sales table having a date/time column, a practice identifier column, a product identifier column, and a quantity column.

15. A computer-implemented method according to claim 2, wherein electronically verifying said prescription drug is available comprises querying a virtual inventory table having a practice identifier column, a product identifier column, and a quantity column.

16. A computer-implemented method according to claim 3, wherein updating said stored inventory data comprises inserting a row into a purchases table having a date/time column, a practice identifier column, a product identifier column, and a quantity column.

17. A computer-implemented method according to claim 4, wherein electronically verifying that said requested quantity of said prescription drug is available in an actual inventory comprises querying a virtual inventory table having a practice identifier column, a product identifier column, and a quantity column.

18. A computer-implemented method according to claim 5, wherein calculating said total cost to patients comprises querying a sales table having a date/time column, a practice identifier column, a product identifier column, and a quantity column; and wherein calculating a total cost to said practice comprises querying a purchases table having a date/time column, a practice identifier column, a product identifier column, and a quantity column.

19. A computer-implemented method according to claim 8, wherein calculating said total cost to said practice comprises querying a purchases table having a date/time column, a practice identifier column, a product identifier column, and a quantity column.

20. A computer-implemented method according to claim 1, wherein said inventory data and said doctor registration data are stored in a common database.
